(19) United States
(12) Patent Application Publication
(10) Pub. No.: US 2007/0118265 A1
(43) Pub. Date: May 24, 2007

(54) OCCUPANT CLASSIFYING SYSTEM AND METHOD OF VEHICLE

(75) Inventor: Kuk Ki IM, Suwon-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD, Yongin-shi (KR)

(21) Appl. No.: 11/425,952

(22) Filed: Jun. 22, 2006

(30) Foreign Application Priority Data
Nov. 23, 2005 (KR) 10-2005-0112094
Dec. 21, 2005 (KR) 10-2005-0127274
Dec. 21, 2005 (KR) 10-2005-0127275

(51) Int. Cl. B60R 22/00

(52) U.S. Cl. 701/45

(57) ABSTRACT

An occupant classifying system and method includes a weight sensing unit provided in a seat, a central processing unit classifying the occupant into any one of various classes pre-set using the information acquired by the weight sensing unit, and regulators applying power to the weight sensing unit and central processing unit and initializing the central processing unit whenever the central processing unit is applied with power. The occupant classifying system and method provides a high accuracy and reliability, since the system and method are initialized when the vehicle's ignition is started and classify the occupant by information acquired through the weight sensing unit.

This application claims priority on Patent Application No. 10-2005-0112094 filed in Korea on Nov. 23, 2005, No. 10-2005-0127274 filed in Korea on Dec. 21, 2005, and No. 10-2005-0127275 filed in Korea on Dec. 21, 2005, the entire contents of hereby incorporated by reference.

### BACKGROUND OF THE INVENTION

1. Field of the Invention

present invention relates to an occupant classifying system and of a vehicle, and more particularly, to an occupant classifying system and method of a vehicle which, after being initialized with the system's ignition on, classifies an occupant using information acquired from a weight sensing unit provided in a seat.

2. Description of the Related Art

In general, occupant protecting devices such as an airbag 2 are mounted in a vehicle to enhance the safety of an occupant getting in the vehicle as shown in FIG. 1.

Among the occupant protecting devices, an airbag is a device which is instantaneously inflated by high pressure of deployment gases, and its deployment pressure may be excessive or short according to the physical conditions of the occupant to be protected by the occupant protecting device.

Accordingly, along with the occupant protecting devices, an occupant classifying system has been developed for evaluating the body conditions of an occupant in the vehicle so that the occupant protecting device can operate optimally according to the body conditions of the occupant in the vehicle.

An occupant classifying system according to the prior art classifies an occupant into any one of various classes based on the occupant's weight.

And, the occupant classifying system transmits to the occupant protecting device such as the airbag the occupant classifying information classified into any one of various classes.

The occupant classifying system is directly connected to a battery provided in the vehicle and supplied with power recharged in the battery.

That is, the occupant classifying system is activated if satisfying a condition to escape from a sleep mode, such as the vehicle's ignition on, with the battery recharged with power.

And, the occupant classifying system is initialized if the vehicle's ignition is off, and continues to receive power from the battery while operating in the sleep mode in which the occupant classifying system maintains inactivated state.

However, the occupant classifying system and method of the vehicle according to the prior art continue to supply power from the battery to the system even after the vehicle's ignition is off, thus leading to the battery's continuous power consumption.

Therefore, the battery is easily discharged, and if the vehicle's ignition is off and the battery consumes even more power, When the vehicle's ignition is restarted, the power supply from the battery is instable. This obstructs the normal driving of the vehicle as well as the occupant classifying system and causes mal-operation of the weight detecting sensor, and, as a result, this may lower the accuracy and reliability of the occupant classifying system.

Moreover, since the occupant classifying system and method of the vehicle are initialized after the vehicle's ignition is off, they fail to reflect the state change or variation of the vehicle from the ignition-off to the ignition restart, and this may reduce the accuracy and reliability of the system.

### SUMMARY OF THE INVENTION

The present invention is designed to overcome the above problems of the prior art, and provides an occupant classifying system and method of a vehicle which may receive power and be initialized when the vehicle's ignition is started and then classify an occupant into any one of various classes using information acquired from a weight sensing unit.

An occupant classifying system of a vehicle according to the present invention to solve the above problems includes a weight sensing unit provided in a seat, a central processing unit classifying the occupant into any one of various classes pre-set using the information acquired by the weight sensing unit, and regulators applying power to the weight sensing unit and central processing unit and initializing the central processing unit whenever the central processing unit is applied smith power.

In addition, an occupant classifying method of a vehicle according to the present invention to solve the above problems includes ininitalizing a vehicle if the vehicle's ignition is on, and classifying an occupant by information acquired through a weight sensing unit provided in a seat if the vehicle is initiialized.

### BRIEF DESCRIPTION OF THE DRAWINGS

The embodiment of the invention will be described in detail with reference to the following drawings in which like numerals refer to like elements.

FIG. 1 is a view of illustrating an airbag, one of occupant protecting devices of a general vehicle.

FIG. 2 is a prospective view of illustrating a partial construction of an occupant classifying system of a vehicle according to the present invention.

FIG. 3 is a constructional view of an occupant classifying system of a vehicle according to the present invention.

FIG. 4 is a flow chart of an occupant classifying method by an occupant classifying system of a vehicle according to the present invention.

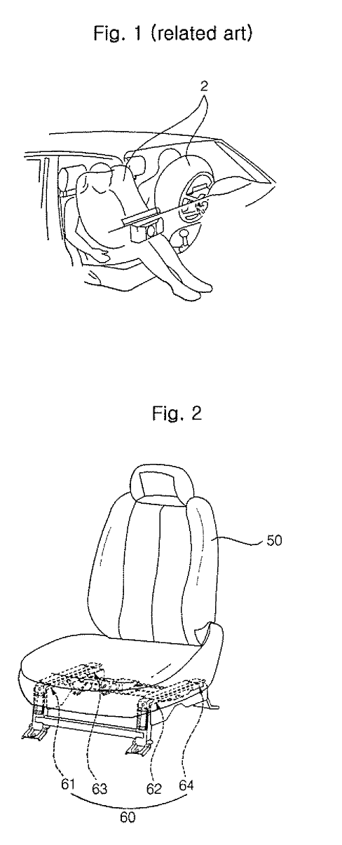

### DETAILED DESCRIPTION OF PREFERRED EMBODIMENTS

Hereafter, preferred embodiments of the present invention will be described in a more detailed manner with reference to the accompanying drawings.

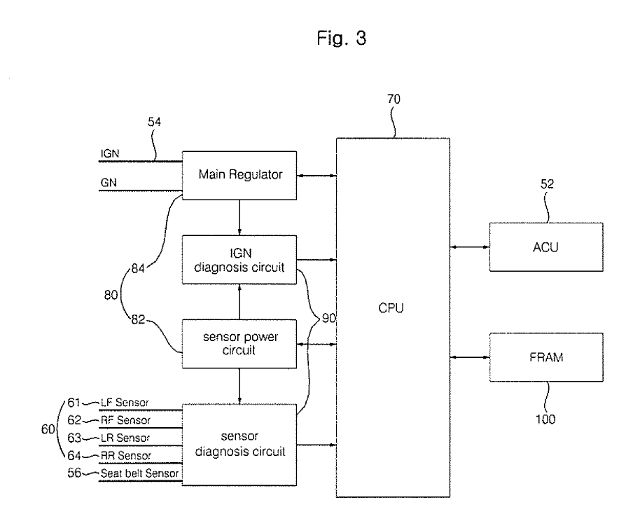

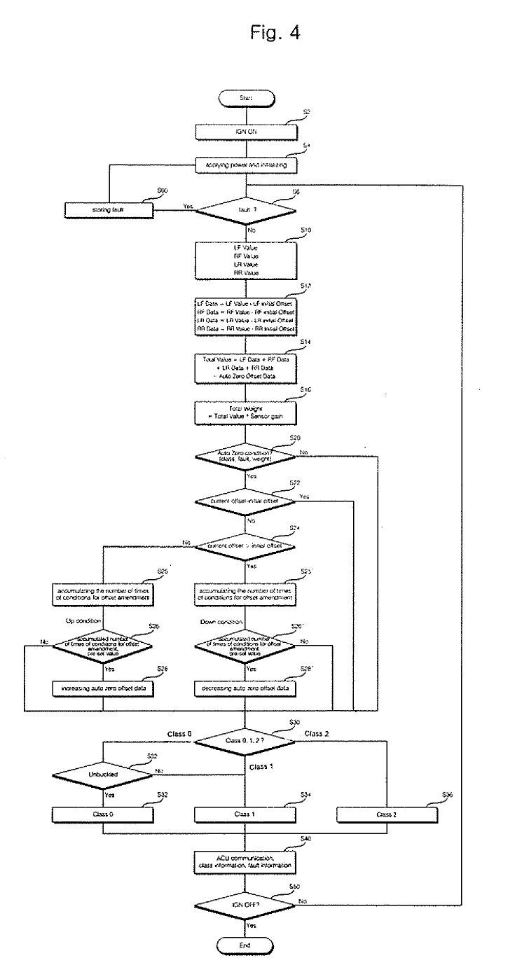

FIG, 2 is a prospective view of illustrating a partial construction of an occupant classifying system of a vehicle according to the present invention, and FIG. 3 is a constructional view of an occupant classifying system of a vehicle according to the present invention. FIG. 4 is a flow chart of an occupant classifying method by an occupant classifying system of a vehicle according to the present invention.

The occupant classifying system according to the present invention is mounted in a passenger seat and includes a weight sensing unit 60 provided in a seat 50, on which an occupant is seated, and sensing the occupant's weight, a central processing unit 70 classifying the occupant into any one of various classes pre-set using the information acquired by the weight sensing unit 60, and regulators 80 applying power to the weight sensing unit 60 and central processing unit 70 and initializing the central processing unit 70 whenever the central processing unit 70 is applied with power.

The weight sensing unit 60 comprises weight detecting sensors mounted on at least one point below the seat 50.

As an example, the weight detecting sensor may include a LF weight detecting sensor 61 placed in a left and front side LF of the seat 50, a RE weight detecting sensor 62 placed in a right and front side RF of the seat 50, a LR weight detecting sensor 63 placed in a left and rear side LR of the seat 50, and a RR weight detecting sensor 64 placed in a right and rear side RR of the seat 50.

The central processing unit 70 calculates the occupant's weight using information for calculating the occupant's weight pre-set in the central processing unit 70 and information for calculating the occupant's weight to be inputted to the central processing unit 70, and classifies the occupant into any one of various classes pre-set through the calculated information for the occupant's weight.

The central processing unit 70 is connected through a K-line communication to an airbag control unit 52 so that the occupant classifying information processed in the central processing unit 70 may be transmitted to an airbag control unit 52 which controls an airbag according to the occupant's occupancy or vacancy and physical conditions of the occupant seated in the seat 50.

The regulators 80 are provided to apply ignition power 54 to the weight sensing unit 60 and central processing unit 70 so that the occupant classifying system according to the present invention may operate only while the vehicle's ignition is off to prevent the power consumption of the battery after the vehicle's ignition is off.

In addition, the regulators 80 allow the weight sensing unit 60 and central processing unit 70 to be applied with the ignition power 54 independently with each other so that the ignition power 54 may be stably supplied to the weight sensing unit 60 and central processing unit 70, respectively.

That is, the regulators 80 may be separated into a regulator 82 for a sensor, which converts the ignition power 54 into a voltage suitable for the weight sensing unit 60, VCC (for example, 5V) when the vehicle's ignition is started and applies the converted voltage to the weight sensing unit 60, and a regulator 84 for a CPU, which converts the ignition power 54 into a voltage suitable for the central processing unit 70, VCC (for example, 5V) when the vehicle's ignition is started and applies the converted voltage to the central processing unit 70.

The regulator 84 for the CPU may have a function to output an automatic reset signal to the central processing unit 70 so that the central processing unit 70 may be initialized whenever the ignition power 54 is applied to the central processing unit 70.

The regulator 84 for the CPU may also have a ‘watch-dog’ function to output a compulsory reset signal to the central processing unit 70 so that the central processing unit 70 may be re-initialized in a case where the central processing unit 70 is abnormally operated and turned off under the vehicle's on.

On the other hand, the occupant classifying system according to the present invention further includes diagnosis circuit units 90 for diagnosing the occupant classifying system according to the present invention including whether the central processing unit 70, regulators 80 as well as the weight sensing unit 60 work normally.

The diagnosis circuit units 90 serve to diagnose the occupant classifying system according to the present invention such as whether the weight sensing unit 60 operates well as well as whether the ignition power 54, VCC, automatic reset signal and compulsory reset signal are outputted normally,

Furthermore, the occupant classifying system according to the present invention includes a memory unit 100 for storing and maintaining the evaluating values from the weight sensing unit 60, primary information, and the diagnosing result from the diagnosis circuit units 90.

The memory unit 100 does store the information not through a separate diagnosing mode but in a real time, and it may be implemented by a FRAM which may maintain the stored information even after the vehicle's ignition is off.

Meanwhile, it is generally obligatory that the occupant to be seated in a driver's seat and passenger's seat should fasten the seat belt. Therefore, the occupant classifying system according to the present invention may further include a seat belt fastening and detecting sensor 56 which confirms whether the occupant fastened the seat belt or not, so that the central processing unit 70 may check prudently once more whether the occupant occupied his seat, and then classify the occupant when the central processing unit 70 classifies the occupant according to the occupant's weight.

An occupant classifying method by the occupant classifying system of a vehicle according to the present invention configured as mentioned above will be described as follows.

When the vehicle's ignition is started (step S2), the regulators 80 apply power to the weight sensing unit 60 and central processing unit 70 and at the same time outputs a automatic reset signal to the central processing unit 70 to thereby initialize the central processing unit 70 (step S4).

The weight sensing unit 60 and central processing unit 70 receive the power and operate as described above, and the diagnosis circuit units 90 perform a diagnosis while the central processing unit 70 is in the initialized state (step S6).

If the diagnosis circuit units 90 determine that the weight sensing unit 60, central processing unit 70, and regulators 80 are all operated normally, then an occupant weight calculating mode, which calculates the occupant's weight, commences.

The occupant weight calculating mode is implemented as follows, If the occupant weight calculating mode initiates, then the weight sensing unit 60 detects the weight and outputs the resulting signal to the central processing unit 70.

The signal from the weight sensing unit 60 outputted to the central processing unit 70 is A/D converted and then stored as a LF value, RF value, Lk value, and RR value in the central processing unit 70 (step S10).

The LF value is one which is A/D converted from the output signal of the LE weight detecting sensor 61, the RF value is one which is A/D converted from the output signal the RF weight detecting sensor 62, the LR value is one which is A/D converted from the output signal of the LR weight detecting sensor 63, and the RN value is one which is A/D converted from the output signal of the RR weight detecting sensor 64.

If the signal is stored in the central processing unit 70 as the LF value, RF value, LR value, and RR value, then the central processing unit 70 produces a LF data, RF data, LR data, and RR data to be yielded by deducting an offset value of the weight sensing unit 60 pre-set in the central processing unit 70 from each of the LF value, RF value, LR value, and RR value (step S12).

The offset value of the weight sensing unit 60 is one which is A/D converted from a signal which under a state that no load is applied on the seat 50, namely, the occupant's weight is ‘0’, the weigh sensing unit 60 Outputs to the central processing unit 70.

The offset value of the weight sensing unit 60 may be applied to the four weight detecting sensors 61 to 64 with the same value, or may be applied differently to each of the weight detecting sensors 61 to 64. Hereinafter, the offset value of the LF weight detecting sensor 61 is referred to as a LF offset, the offset value of the LF weight detecting sensor 62 is referred to as a RF offset, the offset value of the LR weight detecting sensor 63 is referred to as a LR offset, and the offset value of the RR weight detecting sensor 64 is referred to as a RR offset.

After the LF data, RF data, LR data, and RR data are yielded, all of them are summed, wherein a total value, which reflects the amendment to the offset value of the weight sensing unit 60, is produced from the following equation [Total value equation] (step S14).
Total value={LF data+RF data+LR data+RR data}+offset amendment value [Total value equation]

A zero point, which means a value in which the occupant's weight is 0 among the evaluation values of the weight sensing unit 60, may increase or decrease due to various causes such as impacts from the outside or aging by elapse of time. Therefore, the offset amendment value is for amending the pre-set offset value of the weight sensing unit 60 so that the zero point of the weight sensing unit 60 may be adjusted.

The offset amendment value may be calculated in ‘Auto zero mode’ which will be described later.

If the total value is calculated as above, then the occupant's weight may be yielded from the following equation [occupant's weight producing equation] (stel) S16).
occupant's weight=Total value*sensor gain [occupant's weight producing equation]

where, the total value is produced from the equation [Total value] as follows, and the sensor gain is a pre-set calculation value to yield in a weight concept the evaluating value of the weight sensing unit 60, which the signal inputted from the weight sensing unit 60 is A/D converted.

If the occupant's weight is produced, then the weight producing mode ends, and it is determined whether the conditions for the offset amendment value calculating mode for calculating the offset amendment value are satisfied (step S20).

One of the conditions for the offset amendment value calculating mode is that no occupant should occupy the seat, and this condition is required since the zero point can be adjusted only when nobody should be seated in the seat 50.

Whether the occupant occupies the seat or not may be handled through the occupant classifying information processed by the central processing unit 70. At this time, in a case where the vehicle's ignition is started and then it is for the first time determined whether conditions for the auto zero mode are satisfied, no occupant classifying information exists yet in the central processing unit 70 and thus it is determined that the condition that no occupant should be seated fails to be satisfied.

Another one of the conditions for the offset amendment value calculating mode is that the occupant classifying system should operate normally. Whether the occupant classifying system operates normally or not may be handled through the diagnosis circuit units 90.

Unless all of the conditions for the offset amendment value calculating mode are satisfied, then the offset amendment value calculating mode is not performed. That is, only if all the conditions for the offset amendment value calculating mode should be satisfied, the offset amendment value calculating mode starts.

If the offset amendment value calculating mode commences, then at first a current offset value of the weight sensing unit 60 acquired through the occupant's weight calculating mode and the initial offset value of the weight sensing unit 60 are compared with each other (step S22).

If the current offset value and initial offset value of the weight sensing unit 60 are equal, then the offset amendment value calculating mode ends without varying the pre-set offset amendment value.

Otherwise, in a case where the current offset value and initial offset value of the weight sensing unit 60 are different, if the current offset value of the weight sensing unit 60 is smaller than the initial offset value of the weight sensing unit 60, it is classified into an UP condition, and if the current offset value of the weight sensing unit 60 is greater than the initial offset value of the weight sensing unit 60, it is classified into a DOWN condition (step S24). Herein, since the variation of the zero point of the weight sensing unit 60 may be a temporary phenomenon due to loads from books or bags put on the seat 50, at first, the number of times of the conditions for the offset amendment is accumulated (steps S25 and S25′).

It is desirable that the number of times of the conditions for the offset amendment is accumulated only once, since the loads from books or bags put on the seat 50 can last for long time.

If the number of times of the conditions for the offset amendment is accumulated, then the accumulated number of times of the conditions for the offset amendment is compared with the pre-set value. At this time, the pre-set value to be compared with the accumulated number of times of the conditions for the offset amendment may be different according to whether the classified condition is the UP condition or DOWN condition (steps S26 and S26′).

As a result of the comparison of the accumulated number of times of the conditions for the offset amendment and the pre-set value, if the accumulated number of times of the conditions for the offset amendment is smaller than the pre-set value, then the offset amendment value calculating mode ends without varying the pre-calculated offset amendment value.

Otherwise, if the accumulated number of times of the conditions for the offset amendment reaches the pre-set value, then the pre-calculated offset amendment value is recalculated (steps S28 and S28′).

The offset amendment value can be calculated to allow the offset amendment value to be increased or decreased by a predetermined increment or by the difference of the current offset value and initial offset value of the weight sensing unit 60. At this time, in case of the UP condition, where the current offset value of the weight sensing unit 60 is smaller than the initial value of the weight sensing unit 60, the offset amendment value is increased, and in case of the DOWN condition, where the current offset value of the weight sensing unit 60 is greater than the initial value of the weight sensing unit 60, the offset amendment value is decreased.

If the offset amendment value is calculated as described above, then the offset amendment value calculating mode ends.

In a case where the above invention offset amendment value calculating mode ends or the conditions for the offset amendment value calculating mode fail to be satisfied, an occupant classifying mode starts, which classifies an occupant into any one of various classes using the occupant's weight calculated in the occupant's weight calculating mode.

If the occupant classifying mode starts, then it determines which range of the pre-set various classes the calculated occupant's weight corresponds to (step S30), and classifies the occupant into any one of the pre-set various classes (steps S32, S34, and S36).

Here, the pre-set classes include a class 0 where no occupant is seated in the seat, a class 1 where the occupant is classified into a child or small lady, and a class 2 where the occupant is classified into an adult.

On the other hand, in a case where the occupant is classified into the class 0, the occupant is not immediately determined as the class 0 and it is determined whether the occupant fastens the seat belt (step S38). If the occupant does not fasten the seat belt, then the occupant is determined as the class 0 (step S32), and if the occupant fastens the seat belt, then the occupant is considered as a chilled or small lady and reclassified into the class 1, a level right above the class 0, and then determined as the class 1 (step S34).

If the occupant is determined as any one of the classes, then the occupant classifying mode ends.

If the occupant classifying mode ends, then occupant classifying information acquired through the occupant classifying mode is transmitted through K-line communication to the airbag control unit 52 (step S40).

Hereafter, if the vehicle is on, then the occupant classifying system according to the present invention would repeat all the steps from the beginning, and if the vehicle's ignition is off, then the occupant classifying system would stop the operation (step S50).

On the other hand, as a result of the diagnosis of the diagnosis circuit units 90 (step S4), if any one of the weight sensing unit 60, central processing unit 70, and regulators 80 is diagnosed as being operated abnormally, then the result of the diagnosis would be stored in the memory unit 100 (step S60). The result of the diagnosis may be transmitted through the K-Line communication to the airbag control unit 52 (step S40).

And, if the vehicle is still under operation, then the vehicle classifying system would be forced to be initialized again (step S4).

Although the occupant classifying system and method according to the present invention is described with reference to the exemplary drawings, the invention is not limited to the embodiments and drawings set forth herein, rather it is limited only to the accompanying claims.

The occupant classifying system and method according to the present invention configured and operated as mentioned above are initialized if power is applied and then classify the occupant into any one of various classes using the information acquired from the weight sensing unit, and this allows for optimizing the vehicle's current state, thus making it possible to improve the accuracy and reliability.

Moreover, the occupant classifying system and method according to the present invention configured and operated as mentioned above receive the ignition power so that power is supplied to the vehicle if the vehicle's ignition is started up, and thus may be stably supplied with power, thus making it possible to maximize the accuracy and reliability and to prevent the discharge of the battery when the vehicle's ignition is off.

In addition, the occupant classifying system and method according to the present invention configured and operated as mentioned above may make an amendment to the offset value of the weight sensing unit by implementing the offset amendment value calculating mode and this allows for adjusting a zero point of the weight sensing unit all the time, thus making it possible to maximize the accuracy and reliability. This allows for improving the performance and stability of airbags to be controlled by the occupant classifying information.

In addition, the occupant classifying system and method according to the present invention configured and operated as mentioned above are provided to recalculate the offset amendment value of the weight sensing unit if the offset amendment value of the weight sensing unit is varied over the predetermined number of times, thus making it possible to maximize the accuracy and reliability.

In addition, the occupant classifying system and method according to the present invention configured and operated as mentioned above reconsider the occupant's classification according to whether the occupant fastens or not in a case where the occupant is classified into the class 0, thus making it possible to the accuracy and reliability.

What is claimed is:

1. An occupant classifying system of a vehicle comprising:
a weight sensing unit provided in a seat;
a central processing unit classifying an occupant into any one of a number of classes pre-set using information acquired by the weight sensing unit; and
regulators applying power to the weight sensing unit and central processing unit, the regulators initializing the central processing unit whenever the central processing unit is applied with power.

2. The occupant classifying system of the vehicle of claim 1, wherein the weight sensing unit comprises four weight detecting sensors mounted in each edge of the seat.

3. The occupant classifying system of the vehicle of claim 1, wherein the central processing unit is connected through a K-Line communication to an airbag control unit (ACU) to control an airbag.

4. The occupant classifying system of the vehicle of claim 1, wherein the regulators are provided to allow the weight sensing unit and central processing unit to be applied with an ignition power.

5. The occupant classifying system of the vehicle of claim 2, wherein the regulators are provided to allow the four weight detecting sensors to be applied with power independently with one another.

6. The occupant classifying system of the vehicle of claim 1, further comprising;
a FRAM that stores in a real time the information from the central processing unit.

7. The occupant classifying system of the vehicle of claim 1, further comprising:
a seat belt fastening and detecting sensor that detects whether a seat belt provided in the seat is fastened or not.

8. An occupant classifying method of a vehicle comprising:
ininitalizing a vehicle if the vehicle's ignition is on; and
classifying an occupant by information acquired through a weight sensing unit provided in a seat if the vehicle is initialized.

9. The occupant classifying method of the vehicle of claim 8, wherein said classifying the occupant comprises:
calculating the occupant's weight through the information from the weight sensing unit;
classifying the occupant into any one of various classes according to the occupant's weight calculated if the occupant's weight is calculated; and
calculating an offset amendment value for a zero point adjustment of the weight sensing unit if the occupant's weight is calculated.

10. The occupant classifying method of the vehicle of claim 9, wherein the occupant's weight is calculated through producing the difference between an evaluation value of the weight sensing unit and a pre-set offset value of the weight sensing unit, summing the produced difference and the offset amendment value, and then multiplying the summed value by a pre-set sensor gain.

11. The occupant classifying method of the vehicle of claim 9, wherein, in said classifying an occupant's class, in a case where the occupant's class is classified into a class where no occupant occupies the seat, the occupant's class is determined as the class where no occupant occupies the seat according to whether the seat belt is fastened or not.

12. The occupant classifying method of the vehicle of claim 11, wherein, in said classifying the occupant's class, in a case where the occupant's class is classified into a class where no occupant occupies the seat and the seat belt is under being fastened, the occupant's class is reclassified into a class where an occupant is seated in the seat.

13. The occupant classifying method of the vehicle of claim 9, wherein, in said calculating the offset amendment value, the offset amendment value is increased or decreased by a predetermined increment from the current offset amendment value.

14. The occupant classifying method of the vehicle of claim 9, wherein, in said calculating the offset amendment value, the offset amendment value is increased or decreased by a difference of the current offset value and an initial offset value of the weight sensing unit.

15. The occupant classifying method of the vehicle of claim 9, wherein, in said calculating the offset amendment value, if said calculating the offset amendment is for the first time performed after the vehicle starts, and the current offset value and an initial offset value of the weight sensing unit is different from each other, then the number of times of conditions for the offset amendment is accumulated, and then if the accumulated number of times of the conditions for the offset amendment reaches a pre-set value, then the offset amendment value is produced.

16. The occupant classifying method of the vehicle of claim 9, wherein, in said calculating the offset amendment value, if conditions for executing the offset amendment value calculating mode are satisfied, then said calculating the offset amendment value commences.

17. The occupant classifying method of the vehicle of claim 9, wherein the conditions for executing the offset amendment value calculating mode comprise whether an occupant is seated or not.

18. The occupant classifying method of the vehicle of claim 9, wherein between said initializing and said classifying the occupant's class,
a self-diagnosis is performed.

19. An occupant classifying method of a vehicle comprising:
outputting a value from a weight sensing unit provided in a seat;
calculating a difference between the value from the weight sensing unit and an offset value outputted from the weight sensing unit when an occupant's weight is zero;
producing the occupant's weight by summing the calculated difference and an offset amendment value of the weight sensing unit for an offset amendment of the weight sensing unit and then multifying the summed value by a pre-set sensor gain; and
classifying the occupant into any one of various pre-set classes according to the produced occupant's weight.
